(19) United States
(12) Patent Application Publication
(10) Pub. No.: US 2011/0141514 A1
(43) Pub. Date: Jun. 16, 2011

(54) IMAGE PROCESSING APPARATUS AND CONTROL METHOD THEREFOR

(75) Inventor: Nobuyoshi Kakigi, Kawasaki-shi (JP)

(73) Assignee: CANON KABUSHIKI KAISHA, Tokyo (JP)

(21) Appl. No.: 12/942,848

(22) Filed: Nov. 9, 2010

(30) Foreign Application Priority Data
Dec. 11, 2009 (JP) 2009-282292

(51) Int. Cl. G06F 3/12

(52) U.S. Cl. 358/1.15

(57) ABSTRACT

An image processing apparatus having a function of image processing on a file stored in a storage device includes an interface unit configured to read data from the storage device, an acquisition unit configured to acquire information about files stored in the storage device, via the interface unit, a display unit configured to display the information acquired by the acquisition unit, and a determination unit configured to determine whether the image processing apparatus can process a file stored in the storage device, based on a predetermined size of data of the file stored in the storage device. The display unit displays information acquired by the acquisition unit in a manner reflecting the determination result by the determination unit.

### BACKGROUND OF THE INVENTION

1. Field of the Invention

The present invention relates to an image processing apparatus and a control method for the apparatus for processing image data stored in a storage device.

2. Description of the Related Art

Heretofore, there has been known a printing apparatus provided with a direct print function to print data stored in a removable memory.

To perform the direct print function, it is common to attach a removable memory to a printing apparatus and select a file in the removable memory from the operation unit, and issue a command to print. However, when there are a large number of files stored in the removable memory, it is difficult to identify a file as a print object from the operation unit of a printing apparatus which is only capable of simple display.

In many cases, the formats of files that can be printed on the printing apparatus are often limited to specific types. On the display screen of the printing apparatus with limited display function, it is difficult to discriminate whether a file in the removable memory is in a printable format.

For this reason, it is possible to know whether a file is in printable format only after a user tries to print the file as a test. Thus, the operability is not high in operating the direct print function.

Japanese Patent Application Laid-Open No. 2007-4247 discusses a printing system, including a reading unit to read information in a removable memory, an external storage medium to store image data, and a determination unit to determine whether direct print is possible through analysis of image data. When data for direct print is application data, which requires PDL conversion, this printing system can execute printing by converting application data into PDL data by a server capable of PDL processing, prior to the printing of the data.

In Japanese Patent Application Laid-Open No. 2007-4247, however, if there is not a server capable of PDL conversion, a problem occurs as follows. After all steps have been completed, from a step that a user selects a file and issues a command to print to a step that a server, which is capable of converting job data into PDL data, is searched, then it turns out that the file cannot be printed. It is a considerable length of time after the user issued a command to print before the user knows that the file cannot be printed. Moreover, there is no way to prevent the user from selecting a wrong file that cannot be converted into PDL data in advance.

Whether a file is of a type that allows the user to perform direct print can be determined according to an extension of the file. However, among JPEG format files, there are various types of JPEG files, such as a progressive JPEG format and a baseline JPEG format, for example.

An image processing apparatus cannot necessarily process all types of JPEG files. Those types of files cannot be discriminated by extensions. The above-described problem applies not only to files stored in a removable memory but also to files stored in fixed storage devices, such as a hard disk and a solid state drive (SSD).

### SUMMARY OF THE INVENTION

The present invention is directed to an image processing apparatus capable of determining whether a file stored in a storage device can be processed, and notifying a user of a result of the determination.

According to an aspect of the present invention, an image processing apparatus having a function of image processing on a file stored in a storage device, includes an interface unit configured to read data from the storage device, an acquisition unit configured to acquire information about files stored in the storage device, via the interface unit, a display unit configured to display information acquired by the acquisition unit, and a determination unit configured to determine whether the image processing apparatus can process a file stored in the storage device, based on a predetermined size of data of the file stored in the storage device, wherein the display unit displays the information acquired by the acquisition unit in a manner reflecting a determination result by the determination unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram schematically illustrating an example of a system included in a printing apparatus according to an exemplary embodiment of the present invention.

FIG. 2 is a block diagram illustrating an example of a hardware configuration of a video controller according to the exemplary embodiment of the present invention.

FIG. 3 illustrates an example of display on an operation unit according to the exemplary embodiment of the present invention.

FIG. 4 is a table illustrating an example of a structure of information about files in a medium according to the exemplary embodiment of the present invention.

FIG. 5 is a flowchart illustrating an example of processing in the printing apparatus according to the exemplary embodiment of the present invention.

FIG. 6 is a flowchart illustrating an example of processing to determine a file format according to the exemplary embodiment of the present invention.

FIGS. 7 (7A and 7B) is a flowchart illustrating another example of processing in the printing apparatus according to the exemplary embodiment of the present invention.

FIG. 8 illustrates an example of display on an operation unit according to the exemplary embodiment of the present invention.

FIGS. 9A and 9B illustrate examples of display on the operation unit according to the exemplary embodiment of the present invention.

FIG. 10 illustrates an example of display on the operation unit according to the exemplary embodiment of the present invention.

### DETAILED DESCRIPTION OF THE EMBODIMENTS

Various embodiments, features, and aspects of the invention will be described in detail below with reference to the drawings.

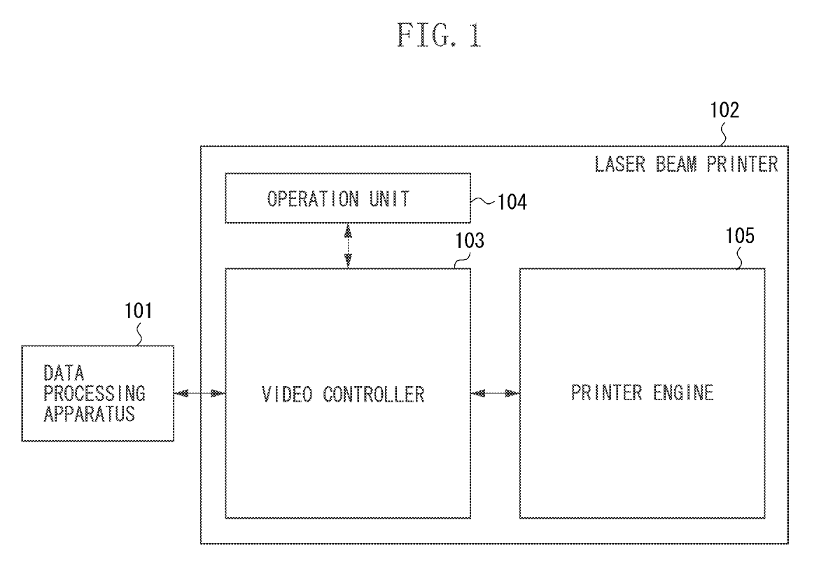

FIG. 1 is a block diagram schematically illustrating a system included in an image processing apparatus according to an exemplary embodiment of the present invention.

A data processing apparatus 101 as an example of the image processing apparatus is a personal computer that supplies image information, and controls a printer. For a printing apparatus 102, which is an example of the image processing apparatus, a laser beam printer (LBP) is used in the present exemplary embodiment.

The printing apparatus 102 is not limited to the laser beam printer, but may be a copying machine, a facsimile machine, or a multifunction peripheral with a plurality of functions of those separate devices. For example, a printer of some other printing method, such as an ink-jet printer, may be used. The data processing apparatus 101 and the printing apparatus 102 are connected over a network or via a local interface, such as USB interface.

A video controller 103 analyzes and rasterizes image information (ESC code, page description language, for example) supplied from the data processing apparatus 101, generates raster data, and sends the data to a printer engine 105. The printer engine 105 forms images by using a well-known electro-photographic method according to the raster data supplied from the video controller 103.

An operation unit 104 is used as a user interface. The user can specify desired operations. The operation unit 104 displays processing contents in the printing apparatus 102 and warning messages to the user. When the printing apparatus 102 is in power saving mode, the display of the operation unit 104 is turned off.

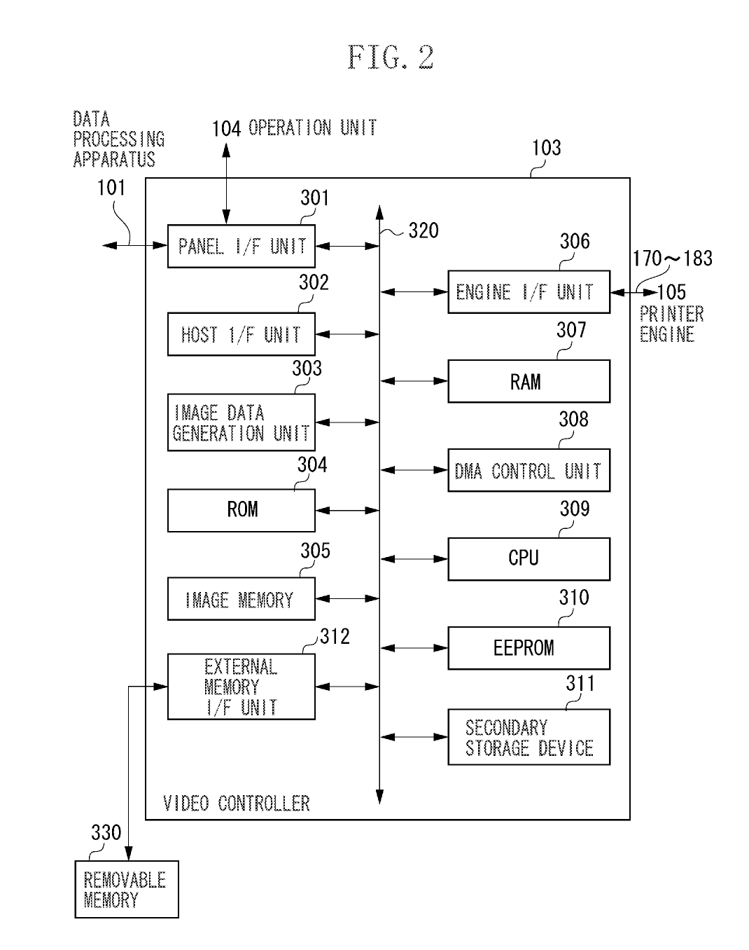

FIG. 2 is a block diagram illustrating an example of a hardware configuration of the video controller 103.

A panel I/F unit 301 is an interface with the operation unit 104. A host I/F unit 302 is an interface to communicate with the data processing apparatus 101, such as a host computer, via a network or a USB connector, and also interactively communicates with information terminal devices, such as personal digital assistants (PDA) (not shown), and cellular phones (not shown).

An image data generation unit 303 generates raster data to be supplied to the printer engine 105 according to the image information, such as PDL data, supplied from the data processing apparatus 101. An image memory 305 temporarily holds the raster data generated by the image data generation unit 303. The image memory 305 may by formed by a nonvolatile storage medium, or a RAM 307 or an EEPROM 310 may also serve as the image memory 305.

An engine I/F unit 306 is an interface to supply the printer engine 105 with raster data and commands to the printer engine 105, or receive information indicating the status of the printer engine 105.

A CPU 309 controls the devices connected to a CPU bus 320 according to program code held in a ROM 304. The CPU 309 can recognize contents that the user set and specifies on the operation unit 104 via a panel interface unit 301. The CPU 309 can recognize the status of the printer engine105 via the engine interface unit 306.

The RAM 307 provides a storage area for temporary storage, used by the CPU 309. The capacity of the RAM 307 can be increased by an optional memory to be connected to an expansion port (not shown).

A direct memory access (DMA) control unit 308 transfers raster data in the image memory 305 to the engine interface 306 in response to a command from the CPU 309. The EEPROM 310 is formed by a nonvolatile memory to hold information about a density correction table, for example. A secondary storage device 311, which is formed by a solid state drive (SSD), for example, holds the print data.

An external memory I/F unit 312 is an interface to attach a detachable storage medium, i.e., a removable memory 330, such as a USB memory, or SD card, and exchange data between the removable memory and the video controller.

The CPU bus 320 includes an address bus, a data bus, and a control bus. The parts and devices connected to the CPU bus 320 include the panel I/F unit 301, the host I/F unit 302, the image data generation unit 303, the ROM 304, the image memory 305, the engine I/F unit 306, the RAM 307, the DMA control unit 308, the CPU 309, the EEPROM 310, the secondary storage device 311, and the external memory I/F unit 312.

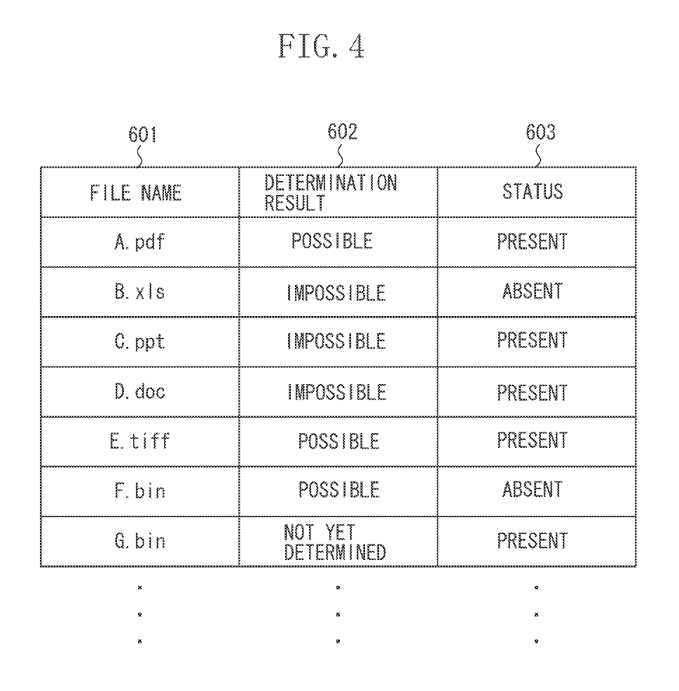

FIG. 4 is a table illustrating an example of a structure of information about files in a medium according to the exemplary embodiment of the present invention.

The information about files in a medium is management information for display of a list of files stored in the removable memory 330 on the operation unit 104. The information about files in a medium is stored in the RAM 307. A file name 601 indicates names of files stored in the removable memory 330.

A determination result 602 in the list indicates whether processing (printing, for example) of files by the printing apparatus 102 is possible. The determination results are “possible”, “impossible”, or “not yet determined”. A status 603 indicates whether the files are present in the removable memory. If a file has been deleted halfway through, the status is “Absent”.

How the information about files in a medium is generated and how the information is used will be described in detail below.

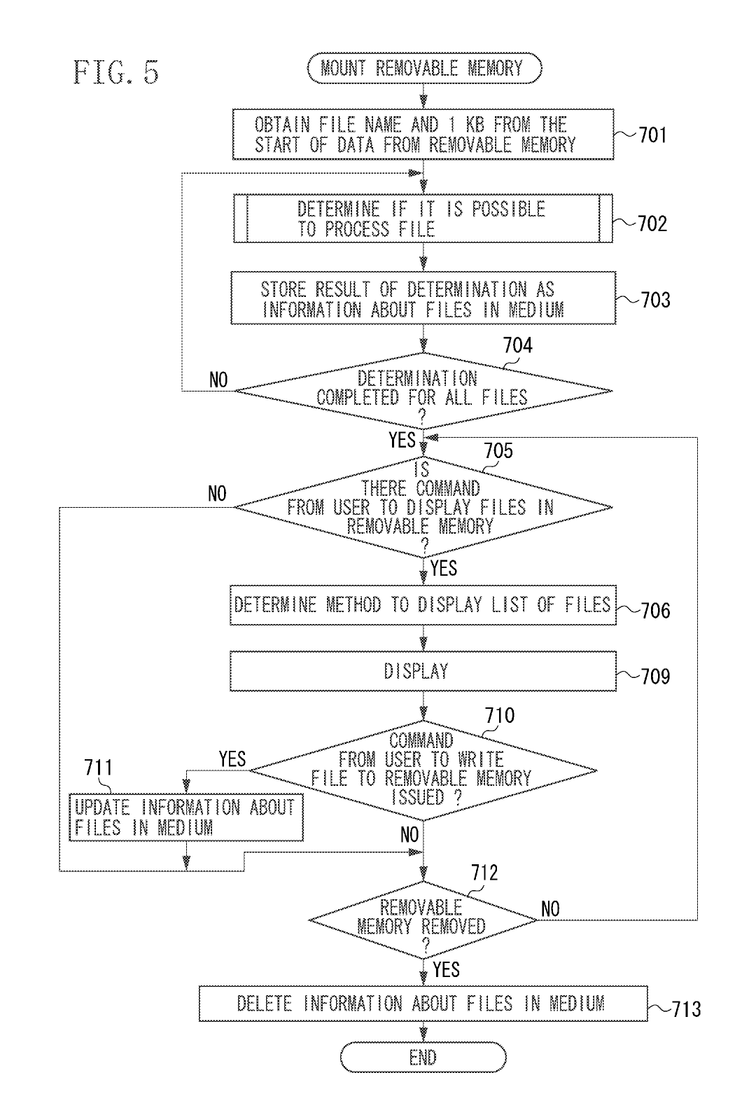

FIG. 5 is a flowchart illustrating an example of processing in the printing apparatus 102 according to the present exemplary embodiment. The steps of the flowchart are executed by the CPU 309 of the printing apparatus 102.

When the removable memory 330 is attached to the printing apparatus 102, the CPU 309 starts to execute the operations of the flowchart.

In step S701, the CPU 309 detects a file stored in the removable memory 330, and acquires its file name and a predetermined amount (predetermined size) of data from the beginning of the file. In this exemplary embodiment, the predetermined amount (size) of data is 1 KB.

Data to be acquired is a number of bytes necessary to detect features of a command and a data format included in a file. The predetermined amount of required data varies depending on the types of files. Therefore, the number of bytes as the predetermined amount of data described above may be changed according to the types of files that are identified by extensions of file names.

In step S702, the CPU 309 acquires 1 KB of data from the beginning of the detected file. The CPU 309 analyzes the data, and determines whether the file can be processed (printed). More specifically, the CPU 309 analyzes the 1 K bytes of data from the beginning of the file, and determines whether the printing apparatus 102 carries a parser for a file format of the file.

A parser is a program that interprets a specific file format, and converts the file into data for print processing by the printing apparatus 102. The parser, instead of being used as a program, may be implemented as hardware, and mounted in the printing apparatus 102. The operation performed in step S702, is performed to identify data received from the data processing apparatus 101. The operation in step S702 will be described in detail later.

The processing proceeds to step S703, a determination result in step S702 is stored in the column of the determination result 602 in the information about files in a medium in FIG. 4. The operations in steps S702 and S703 are performed on all files stored in the removable memory 330. In step S704, the CPU 309 determines whether the determination operation in step S702 has been performed on all files stored in the removable memory 330.

If the determination in step S702 has been performed on all files (YES in step S704), the processing proceeds to step S705. The operations from step S702 to step S704 are performed on the files in the removable memory. However, those operations may be preferentially performed on the files which are displayed earlier on the operation unit 104 than the files which are displayed later.

To begin with, several files, which are to be displayed earlier on the operation unit 104, are previously processed in the steps S702 to S705, and while those files are displayed on the operation unit 104, the files which are more likely to be displayed next are processed. With this arrangement, it becomes possible to display files at high speed even if there are a large number of files in the removable memory.

By changing the order of priority in processing variable according to display styles, such as in chronological order of dates, in order of a specific filing system, or in an alphabetical order, the files can be displayed at high speed regardless of display style.

In the subsequent steps, the processing is executed according to the operations performed by the user on the operation unit 104. In step S705, when a command is received from the user to display a list of files stored in the removable memory 330, on the operation unit 104 (YES in step S705), the processing proceeds to step S706. In step S706, the CPU 309 determines a method to display the list of files based on the information about files in a medium.

More specifically, the CPU 309 makes a decision to put a circle mark to a file on which the printing apparatus 102 can perform processing (printing). In step S709, the CPU 309 displays a list of files in the removable memory 330, on the operation unit 104 according to the display method determined in step S706.

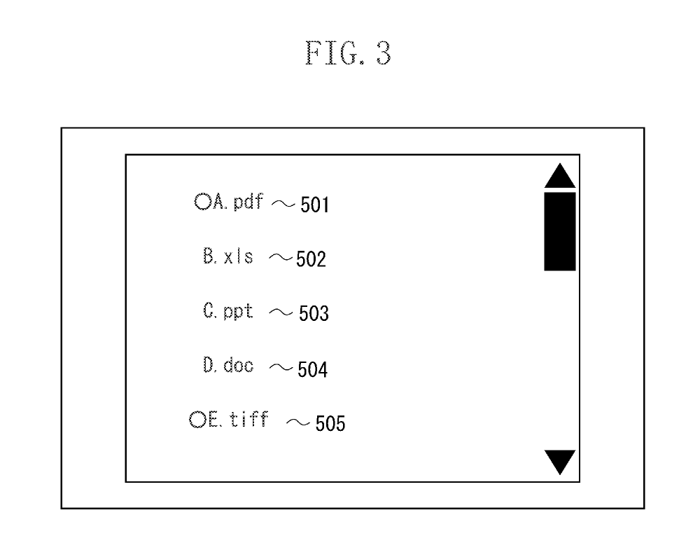

FIG. 3 illustrates an example of display on an operation unit according to the present exemplary embodiment.

FIG. 3 illustrates a list of files displayed on the operation unit 104 by the operation in step S709. In FIG. 3, the operation unit 104 displays file names as information about files stored in the removable memory 330 attached to the printing apparatus 102.

The circle mark is added in front of each of A.pdf 501 and E.tiff 505. The circle mark indicates that the file can be processed (in direct print, for example) by the printing apparatus 102. On the other hand, the files 502, 503, and 504 are not added with the circle mark, which indicates that direct print cannot be performed on those files.

The addition of this circle mark reflects the determination in step S706. The other file names, such as F.bin, can be displayed by operating the scroll bar. As it is clear by referring to the information about files in a medium that F.bin is a file processable by the printing apparatus 102, a circle mark is added to the F.bin file.

Returning to the description of the flowchart in FIG. 5, in step S710, if the user gives an instruction to write (delete or add) a file to the removable memory 330 (YES in step S710), the processing proceeds to step S711, the CPU performs determination of step S702 about a file in which some change has occurred, and updates the information about files in a medium. The operations from step S705 to step S711 are repeated until the removable memory 330 is removed. When the removable memory 330 is removed (YES in step S712), the processing proceeds to step S713, the CPU 309 deletes the information about files in a medium, at which the processing of this flowchart ends.

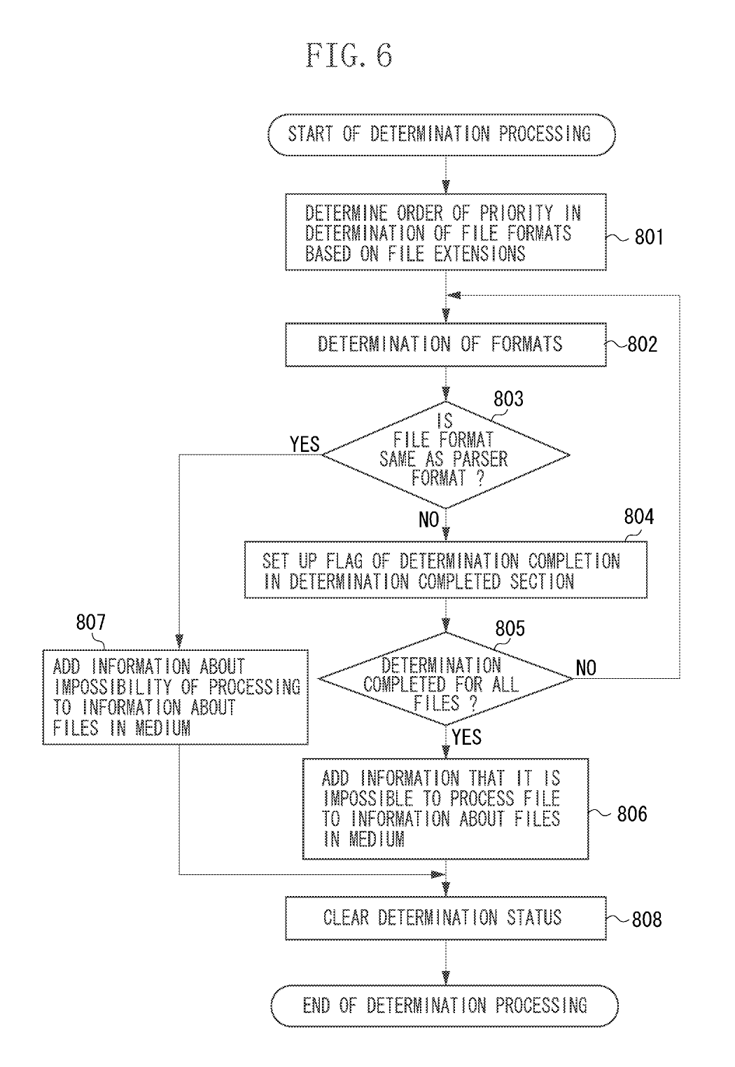

FIG. 6 is a flowchart illustrating an example of processing to determine a file format according to the present exemplary embodiment. FIG. 6 is the flowchart illustrating details of step S702 in the flowchart of FIG. 5.

In step S801, the CPU 309 determines an order of priority by identifying a plurality of types of files based on extensions of the files to be determined. For example, if a file name as an objet of determination is a file A.pdf, the CPU 309 determines that the file is highly likely to be in a PDF format, and determines an order of priority of PDF format, JPEG format, and TIFF format in this order.

In step S802, the CPU 309 analyzes a predetermined amount (1 KB, for example) of data in the file according to the order of priority determined in step S801, and determines the file format.

In order to identify a type of file format, an extension of a file is commonly used. However, a file format is often further classified. For example, TIFF format and JPEG format each have baseline and progressive formats, for which reason it is impossible to discriminate their differences only by extensions of files.

The PDF format has many versions, which cannot be discriminated only by file extensions. The printing apparatus 102 is not necessarily capable of processing all of subdivided versions of the formats. Extensions of file names may be rewritten by mistake. Thus, it is impossible to determine only by file extensions whether the printing apparatus 102 can process files.

In the present exemplary embodiment, it becomes possible to correctly determine a file format not only by a file extension but also by analyzing a predetermined amount of data out of actual data. Since a file format can be identified without analyzing all actual data, the determination processing does not take long time.

With regard to a method of identifying a type of file format, some examples will be described as follows. For example, in the case of PCL5, an OK decision is made when three or more characteristic commands are detected out of commands of {ec}%-12345{ec}E, {ec}E, {ec}&1, {ec}&a, {ec}&k, {ec}&u, and {ec}9. For example, in the case of PDF, when 5 bytes of data from the beginning of a file is “% PDF-” and connection is recognized, an OK decision is issued.

For example, in the case of TIFF, when the first data of a file, which is a so-called SOI marker, is “ffd8.H”, OK is issued. With regard to a determination as to baseline and progressive formats, if a file is structured in the order of “IFH”, “IFD”, “Long Value”, and “Image Data”, the file format is a baseline TIFF file format, and if a file is structured in the order of pluralities of “IFH” and “Long Value”, and “Image Data”, the file format is a progressive TIFF file format.

Positions where those characteristic commands appear can be specified to some extent according to types of file formats. Therefore, by analyzing some bytes of data from the beginning of a file to the position where such a distinctive command is likely to appear, it becomes possible to correctly and quickly identify a file format (image data pattern).

In step S803, if a file format is the same as a format that can be processed by a currently active parser (YES in step S803), the processing proceeds to step S807, information “Possible” is added to the column of the determination result 602 of a file as an object of determination in the information about files in a medium.

On the other hand, in step S803, if the file format is not the same as the format that can be processed by the currently active parser (NO in step S803), the processing proceeds to step 804, and information “Not yet determined” is added to the column of the determination result 602 of the file under determination in the information about files in a medium. Returning to step S802, the CPU 309 determines whether another parser in the printing apparatus 102 can process the file. The operations from step S802 to step 804 are repeated, and if there is a parser that can process the file, the CPU determines that the file can be processed.

On the other hand, if the file has a file format that cannot be processed by all parsers in the printing apparatus 102 (YES in step S805), the processing proceeds to step S806, information “Impossible” is added to the column of the determination result 602 of the file as the object of determination. After the determination is over and a write operation to the information about files in a medium is completed, the status of determination is cleared, at which the flowchart comes to an end.

The predetermined amount of data acquired in step 802 may be varied by an extension of a file as an object of determination. Acquired data need not necessarily be a predetermined amount from the beginning of the file as a rule, and may be a predetermined amount acquired from the tail end of data, or may be a predetermined number of bytes from a specific byte relative to the beginning of the file. What amount of data is acquired or from which position of a file may be made changeable according to extensions of files as objects of determination.

According to FIGS. 5 and 6, when a list of file names in the removable memory 330 is displayed, marked files and unmarked files are displayed separately. With this, the files that can be processed in the printing apparatus, to which the removable memory is attached, can be distinguished from the files that cannot be processed. Therefore, the user is prevented from mistakenly instructing the printing apparatus to do direct print on files that cannot be processed (printed).

Whether a file as an object of determination can be processed by the printing apparatus is determined not only by an extension of the file, but also by making a check on a predetermined amount of data of the file. Therefore, the accuracy of determination can be improved, and processable files can be displayed quickly in a list view.

When parsing each file in an external memory, an order of priority of parsing a file is made variable by considering file extensions. As a result, generation of information in an external memory can be greatly accelerated.

In the flowchart in FIG. 5, the information about files in a medium is stored in the RAM 307, and this information is deleted when the removable memory 330 is detached from the printing apparatus 102. By having the information about files in a medium stored in the removable memory, the file list display processing can be accomplished at high speed when the removable memory 330, once attached to the printing apparatus 102 in the past, is attached again.

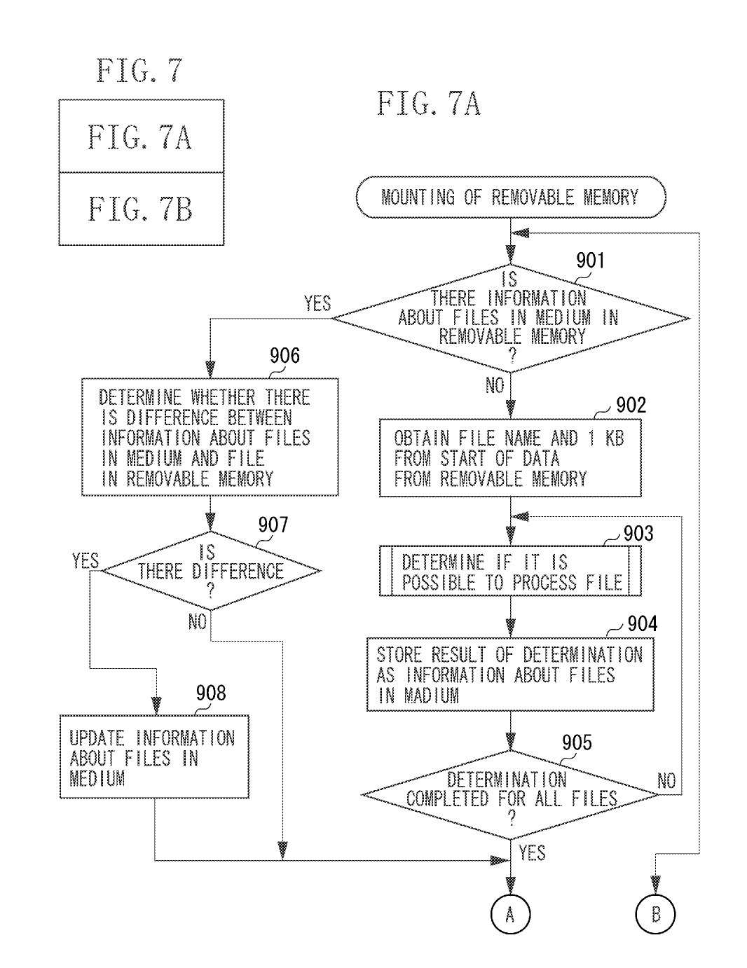

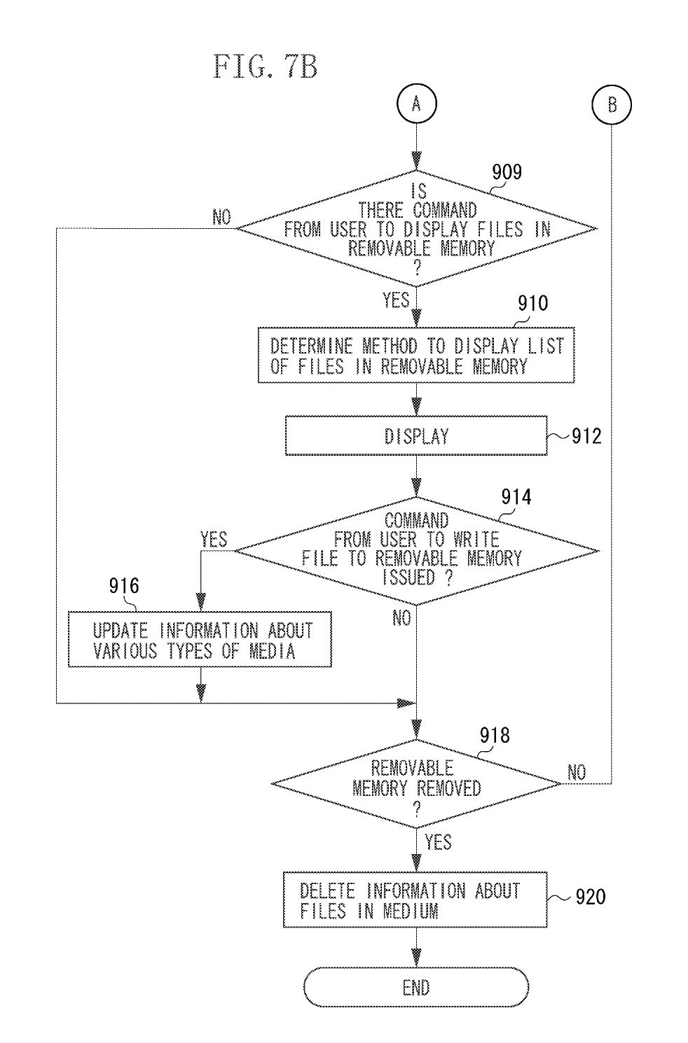

An exemplary embodiment of the printing apparatus 102 when information about files in a medium is stored in the removable memory 330 will next be described. In the following description of an exemplary embodiment, in the printing apparatus 102, the flowchart in FIG. 5 is replaced by a flowchart in FIG. 7, which will be described below.

FIG. 7 is a flowchart illustrating another example of processing by the printing apparatus 102 in the present exemplary embodiment. The operations of this flowchart are executed by the CPU 309 of the printing apparatus 102. When the removable memory 330 is attached to the printing apparatus 102, the CPU 303 starts to execute the steps of this flowchart.

In step S901, the CPU 309 determines whether information about files in a medium is stored in the removable memory 330. If there is information about files in a medium (YES in step S901), the processing proceeds to step S906, where the CPU 309 determines if there is any difference between the information about files in a medium and a file in the removable memory 330. If it is determined that there is some difference (YES in step S907), the processing proceeds to step S908, where the CPU 309 updates the information about files in a medium, and copies the information to the memory of the printing apparatus. Details of the processing performed in step S908 are the same as those illustrated in the flowchart in FIG. 6.

On the other hand, in step S901, if there is no information about files in a medium in the removable memory 330 (NO in step S901), the processing proceeds to step S902. The operations in steps S902 to S905 will not be described in detail because the operations in steps S902 to S905 are the same as those in steps S701 to S704.

Similarly, steps S909, S910, S912, S914, S916, S918, and S920 will not be described in detail because those steps are the same as steps S705, S706, S710, S711, S712, and S713 in FIG. 5.

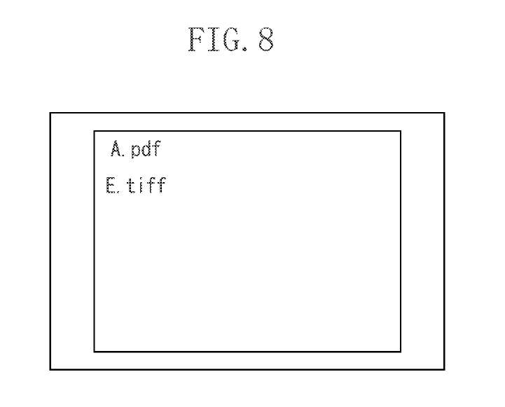

In the above-described exemplary embodiment, as illustrated in FIG. 3, in the list of files in the removable memory 330, the files that can be processed by the printing apparatus 102 are added with a circle mark. However, as illustrated in FIG. 8, only processable files may be displayed. This can prevent the user from selecting files that cannot be processed by the printing apparatus 102, and prevents the user from making operational error3.

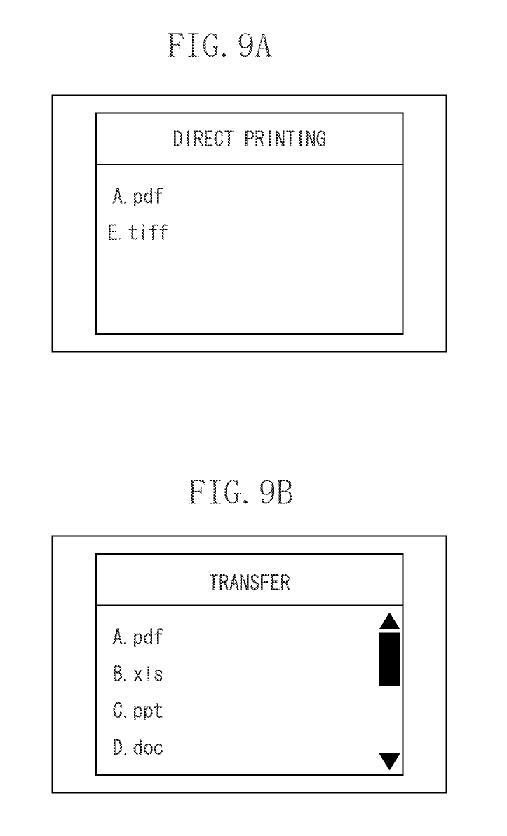

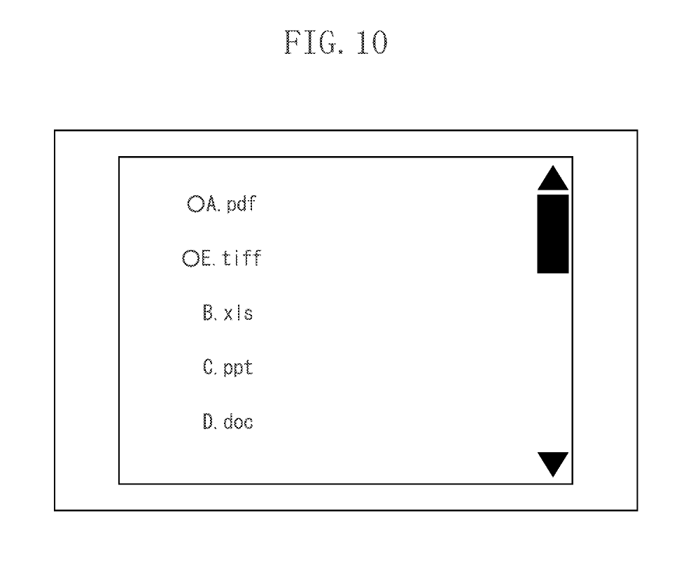

Display contents of a list of files on the operation unit 104 may be changed according to contents of processing that the user causes the printing apparatus to perform. For example, as illustrated in FIG. 9A, in display of a list of files when direct print is performed, the printing apparatus 102 displays only files processable by the printing apparatus 102 in a list view.

As illustrated in FIG. 9B, on an operation screen to send a file to an external device, all files stored in the removable memory 330 are displayed. This is because in processing to send a file to the outside, the file is not printed on the printing apparatus 102. Thus, a suitable list of files can be displayed according to the contents of processing executed by the printing apparatus 102.

When, out of all files stored in the removable memory, only files that can be processed by the printing apparatus 102 are added with a circle mark, instead of display in FIG. 3, the files with the circle-mark may be placed at an upper portion of the list. This arrangement makes it easy for the user to easily select files processable on the printing apparatus 102.

In the above-described exemplary embodiment, a case where a list of files stored in the movable memory 330 is displayed has been described. However, this exemplary embodiment can be applied to a case where a list of files stored in the secondary storage unit 311 is displayed. In this case, the secondary storage unit 311 can store not only print data but also JPEG, PDF, and TIFF files.

According to the present exemplary embodiment, out of files stored in the removable memory, files processable on the printing apparatus 102 can be displayed in a manner distinguishable to the user. Since whether a file is processable on the printing apparatus is determined by analyzing a predetermined amount of data of the file, the determination can be performed quickly and accurately.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-282292 filed Dec. 11, 2009, which is hereby incorporated by reference herein in its entirety.

What is claimed is:

1. An image processing apparatus having a function of image processing on a file stored in a storage device, comprising:
an interface unit configured to read data from the storage device;
an acquisition unit configured to acquire information about files stored in the storage device, via the interface unit;
a display unit configured to display information acquired by the acquisition unit; and
a determination unit configured to determine whether the image processing apparatus can process a file stored in the storage device, based on a predetermined size of data of the file stored in the storage device,
wherein the display unit displays the information acquired by the acquisition unit in a manner reflecting a determination result by the determination unit.

2. The image processing apparatus according to claim 1, wherein the determination unit determines whether the image processing apparatus can process the file, based on the predetermined size of data from the beginning of the file stored in the storage device.

3. The image processing apparatus according to claim 1, wherein the predetermined size is changed according to types of files stored in the storage device.

4. The image processing apparatus according to claim 1, wherein the storage device is a removable memory that can be attached to and removed from the image processing apparatus.

5. The image processing apparatus according to claim 4, further comprising:
a writing unit configured to write information indicating a determination result by the determination unit to the removable storage device.

6. The image processing apparatus according to claim 5, wherein the display unit displays a determination result stored in the removable storage device when the removable storage device attached to the image processing apparatus stores information indicating the result of determination by the determination unit, which is written by the writing unit.

7. The image processing apparatus according to claim 1, wherein out of the files stored in the storage device, the image processing apparatus prints a file determined to be processable by the determination unit.

8. A control method for an image processing apparatus having an interface unit configured to read data from a storage device, comprising:
acquiring information about files stored in the storage device via the interface unit;
displaying the acquired information;
determining whether the image processing apparatus can process a file stored in the storage device, based on a predetermined size of data of the file stored in the storage device; and
displaying the acquired information in a manner reflecting the result of the determination.

9. A computer-readable storage medium storing a program to cause the image processing apparatus to implement the control method according to claim 8.
